(19) United States
(12) Patent Application Publication
(10) Pub. No.: US 2002/0118736 A1
(43) Pub. Date: Aug. 29, 2002

(54) Digital modem

(76) Inventors: Akio Yamaguchi, Tokyo (JP); Mitsuo Iwatake, Tokyo (JP)

Correspondence Address: McGLEW AND TUTTLE, P.C., SCARBOROUGH STATION, SCARBOROUGH, NY, 10510-0827, US

(21) Appl. No.: 09/873,143

(22) Filed: Jun. 1, 2001

(30) Foreign Application Priority Data
Jun. 5, 2000 (JP) 2000-167316

(51) Int. Cl. H04B 1/38; H04L 5/16

(52) U.S. Cl. 375/222

(57) ABSTRACT

[Means to Solve the Problem]

A digital modem comprising a modulation circuit 1 and a demodulation circuit 2 for modulating/demodulating 1/−1 binary signal. 11 of the modulation circuit 1 is a generator of sequence h[k] of finite length, and 12 is a generator of sequence h[−k] of finite length, which is h[k] whose time axis is inverted. A switch 13 is a selector for changing over h[k] and h[−k] according to 1 or −1 input signal, and selects the output of the generator 11 generating h[k] when the input signal is 1, and selects the output of the generator 12 generating h[−k] when the input signal is −1.

21 of the demodulation circuit 2 is a FIR filter having as filter coefficient the sequence h[−k] which is h[k] whose time axis is inverted, and 22 is a FIR filter having as filter coefficient the sequence h[k]. 23 and 24 are square multipliers. A digital modem of simple communication method not requiring complicated diffusion symbol or cycle control, wherein input modulations signals are filtered and output respectively by the FIR filters 21, 22, squared by the square multipliers 23, 24, and the difference of results is determined to obtain the demodulation output, is provided.

### BACKGROUND OF THE INVENTION

1. Field of the Invention

The present invention concerns a digital modem for modulating/demodulating 1/−1 binary signal taking as diffusion signal a signal of which group delay is proportional to the frequency

2. Brief Summary of the Invention

[Problems to be Solved by the Invention]

The spectrum diffusion method transfers a signal by performing the diffusion modulation using noise-like diffusion symbol and by diffusing the signal energy over a band width larger far than the information band width.

Consequently, the carrier band is enlarged to reduce the energy density, allowing to reduce interference to the other radio waves.

The reception side performs the diffusion demodulation using the same diffusion symbol as the transmission side, reducing radio interference based on the diffused signal, and can receive only the desired wave with a high SNR among many existing radio waves.

In general, the spectrum diffusion method uses artificial noise series as diffusion symbol, but requires several conditions such as having a peak sharp in auto-correlation characteristics, cross-correlation characteristics evenly small, and a large number of available kinds of symbol, or others.

Therefore, transmitters and receivers for generating diffusion symbols satisfying these conditions become complicated inconveniently.

Besides, to obtain correlation output by the receiver, it is necessary to synchronize correctly the timing of the reception signal and the reference signal generated at the receiver side.

When the communication starts, as the timing is not known by the receiver side, the receiver side was required to perform considerably complicated synchronization control including operation to search for the connecting timing, operation for holding the obtained timing, or others.

On the other hand, the cross-correlation between a signal h[i] of which group delay is proportional to the frequency and a signal h′[i] which is h[i] right and left inversed on the time axis presents the following characteristics.

According to the definition thereof, the cross-correlation (in short, auto-correlation) of h[i] and h[i] and h′[i] and h′[i] is equal to a linear convolution of h[i] and h′[i] becomes an impulse.

While, the cross-correlation of h[i] and h′[i] is equal to the linear convolution of h[i] and h[i], or h′[i] and h′[i] and becomes substantially 0.

Now, the reason thereof will be described as follows.

h[i] and h′[i] is a kind of sweep signal as shown in FIG. 21 and FIG. 22.

Ordinate axis of the graph represents the frequency (unit: Hz), while abscissa axis the time (unit: sample).

Here, in order to simplify the analysis, the sweep signals h[i], h′[i] are approximated by a cosine signal of which frequency varies gradually as shown in FIG. 23 and FIG. 24.

The sampling frequency is set to 1000 Hz, and the cross-correlation is determined for every 20 samples in correspondence to the frequency variation.

In the following discussion, the signal amplitude scaling is not considered particularly, in order to simplify the description.

In the determination of cross-correlation of \tilde{h}[i] and \tilde{h}[i], the value thereof becomes 40 when the time difference tau is 0 as shown below.

$${\sum }_{i} \tilde{h} [ i ] {\tilde{h} [ i - tau ]}_{tau = 0} = {\sum }_{i = 0}^{79} \tilde{h} [ i ] \tilde{h} [ i ] = {\sum }_{i = 0}^{19} {cos}^{2} \frac{2 π}{1000} 100 i + {\sum }_{i = 20}^{39} {cos}^{2} \frac{2 π}{1000} 200 i + {\sum }_{i = 40}^{59} {cos}^{2} \frac{2 π}{1000} 300 i + {\sum }_{i = 20}^{79} {cos}^{2} \frac{2 π}{1000} 400 i = {\sum }_{i = 0}^{19} [ {cos}^{2} \frac{2 π}{20} 2 i + {cos}^{2} \frac{2 π}{20} 4 i + {cos}^{2} \frac{2 π}{20} 6 i + {cos}^{2} \frac{2 π}{20} 8 i ] = {\sum }_{i = 0}^{18} \{ \frac{1}{2} [ cos \frac{2}{20} 4 i + cos 0 ] + \frac{1}{2} [ cos \frac{2 π}{20} 8 i + cos 0 ] + \frac{1}{2} [ cos \frac{2 π}{20} 12 i + cos 0 ] + \frac{1}{2} [ cos \frac{2 π}{20} 16 i + cos 0 ] \} = {\sum }_{i = 0}^{19} [ \frac{1}{2} cos 0 + \frac{1}{2} cos 0 + \frac{1}{2} cos 0 ] = {\sum }_{i = 0}^{19} 2 = 40$$

On the other hand, when the time difference tau is 20 samples, the cross-correlation becomes 0 as shown below. It is evident from the nature of trigonometric functions as orthogonal functions system.

$${\sum }_{i} \tilde{h} [ i ] {\tilde{h} [ i - tau ]}_{tau = 0} = {\sum }_{i = 0}^{79} \tilde{h} [ i ] \tilde{h} [ i - 20 ] = {\sum }_{i = 20}^{39} cos \frac{2 π}{1000} 200 i \cdot \frac{2 π}{1000} 100 i + {\sum }_{i = 40}^{39} cos \frac{2 π}{1000} 300 i \cdot cos \frac{2 π}{1000} 200 i + {\sum }_{i = 60}^{79} cos \frac{2 π}{1000} 400 i \cdot cos \frac{2 π}{1000} 300 i = {\sum }_{i = 0}^{19} [ cos \frac{2 π}{20} 4 i \cdot cos \frac{2 π}{20} 2 i + cos \frac{2 π}{20} 6 i \cdot cos \frac{2 π}{20} 4 i + cos \frac{2 π}{20} 8 i \cdot cos \frac{2 π}{20} 6 i ] = {\sum }_{i = 0}^{19} \{ \frac{1}{2} [ cos \frac{2 π}{20} 6 i \cdot cos \frac{2 π}{20} 2 i ] + \frac{1}{2} [ cos \frac{2 π}{20} 10 i \cdot cos \frac{2 π}{20} 2 i ] + \frac{1}{2} [ cos \frac{2 π}{20} 14 i + cos \frac{2 π}{20} 2 i ] \} = 0$$

According to similar calculations, obviously, the cross-correlation becomes 0 every time when the time difference tau=±20, ±40, ±60, ±80 as shown below.

$${\sum }_{i}^{79} \tilde{h} [ i ] \tilde{h} [ i - tau ] = 0 \qquad ( tau = 0 , \pm 20 , \pm 40 , \pm 80 )$$

Synthesizing the foregoing results, the cross-correlation of h[i] and h[i] becomes impulse form.

$${\sum }_{i}^{79} \tilde{h} [ i ] \tilde{h} [ i - tau ] = \begin{matrix}40 & ( tau = 0 ) \\ 0 & ( tau = 0 , \pm 20 , \pm 40 , \pm 80 )\end{matrix}$$

Now, the cross-correlation of \tilde{h}[i] and \tilde{h}¹[i] is determined.

The value of cross-correlation becomes 10 when the time difference tau is 20 samples and −20 samples as shown by the following expressions.

$${\sum }_{i} \tilde{h} [ i ] {\tilde{h} [ i - tau ]}_{tau = 0} = {\sum }_{i = 0}^{79} \tilde{h} [ i ] \tilde{h} [ i - 20 ] = {\sum }_{i = 20}^{39} cos \frac{2 π}{1000} 200 i \cdot cos \frac{2 π}{1000} 400 i + {\sum }_{i = 40}^{59} cos \frac{2 π}{1000} 300 i \cdot cos \frac{2 π}{1000} 300 i + {\sum }_{i = 60}^{79} cos \frac{2 π}{1000} 400 i \cdot cos \frac{2 π}{1000} 200 i = {\sum }_{i = 0}^{19} [ cos \frac{2 π}{20} 4 i \cdot cos \frac{2 π}{20} 8 i + cos \frac{2 π}{20} 6 i \cdot cos \frac{2 π}{20} 6 i + cos \frac{2 π}{20} 8 i \cdot cos \frac{2 π}{20} 4 i ] = {\sum }_{i = 0}^{19} \{ \frac{1}{2} [ cos \frac{2 π}{20} 12 i + cos \frac{2 π}{20} 4 i ] + \frac{1}{2} [ cos \frac{2 π}{20} 12 i + cos 0 ] + \frac{1}{2} [ cos \frac{2 π}{20} 12 i + cos \frac{2 π}{20} 4 i ] \} = {\sum }_{i = 0}^{19} \frac{1}{2} cos 0 = {\sum }_{i = 0}^{19} \frac{1}{2} = 10$$

When the time difference tau is other than ±20 samples, the cross-correlation becomes 0 from the nature of trigonometric functions as orthogonal functions system.

The foregoing results can be synthesized as follows.

$${\sum }_{i}^{79} \tilde{h} [ i ] \tilde{h} [ i - tau ] = \{ \frac{10}{0} \begin{matrix}( tau = \pm 20 ) \\ ( tau = 0 , \pm 40 , \pm 60 , \pm 80 )\end{matrix}$$

Synthesizing all results mentioned above, the nature of the cross-correlation of h[i] and h′[i] which is h[i] right and left inversed on the time axis can be expressed by graph as shown in FIG. 25 and FIG. 26.

In the foregoing graph, as continuous sweep signals h[i] and h′[i] are approximated by \tilde{h}[i] and \tilde{h}[i] whose frequency varies gradually, the cross-correlation of \tilde{h}[i] and \tilde{h}[i] presents a relatively large amplitude because the approximation is rough; however, it can easily be understood that this value becomes smaller if the approximation accuracy is improved by subdividing the frequency variation step.

The foregoing results show that the cross-correlation of h[i] and h[i] and the cross-correlation of h′[i] and h′[i] are impulse, the cross-correlation of h[i] and h′[i] becomes almost 0.

In other words, the linear convolution of h[i] and h′[i] becomes an impulse, the linear convolution of h[i] and h[i] becomes substantially 0, and the linear convolution of h′[i] and h′[i] also becomes substantially 0.

Therefore, it is an object of the present invention to provide a digital modem of simple communication method not requiring complicated diffusion symbol or cycle control taking profit of a nature that the auto-correlation and cross-correlation between a signal h[i] of which group delay is proportional to the frequency and a signal h′[i] which is h[i] right and left inversed on the time axis become impulse and substantially 0.

[Means to Solve the Problems]

In order to achieve such object, the present invention is composed as follows.

In short, the invention of claim 1 is a digital modem, comprising:

a modulation circuit for outputting respectively as modulation signal,

a signal h[k] whose amplitude frequency characteristics are constant,

and the phase thereof varies in proportion to the square of the frequency (namely, group delay proportional to the frequency),

when the transmission symbol is 1, and

a signal h[−k] which is the signal h[k] right and left inversed on the time axis,

when the transmission symbol is −1; and

a demodulation circuit for determining the difference between,

the square after linear convolution of this modulation signal and the signal h[−k] which is the sequence h[k] right and left inversed on the time axis, and

the square after linear convolution of the modulation signal and the sequence h[k],

for modulation/demodulation of 1/−1 binary signal.

The invention of claim 2 is the digital modem of claim 1, wherein:

an analogue circuit is adopted for output processing of a modulation signal in said modulation circuit and/or convolution processing of a modulation signal in said demodulation circuit.

The invention of claim 3 is the digital modem of claim 1, wherein.

said signal h[k] is a sequence h whose discrete Fourier transform is

$$DFT ( h [ k ] ) = \{ \begin{matrix}cos β {n}^{2} + j sin β {n}^{2} & ( 0 ≦ n ≦ L / 2 ) \\ cos {β ( L - n )}^{2} - j sin {β ( L - n )}^{2} & ( L / 2 < n < L )\end{matrix}$$

where, L is the length of the sequence h, the range of k is 0≦k<L, and β is a constant taking a value other than 0.

The invention of claim 4 is the digital modem of claim 1, wherein: said signal h[k] is a sequence h making

$$h [ k ] = 1 - 2 {mod}_{2} ( \frac{{k}^{2}}{2 L} )$$

where, L is the length of the sequence h, the range of k is 0≦k<L, mod₂(x) is the remainder of division of x by 2, and x ] is an integer not exceeding x.

The invention of claim 5 is the digital modem of claim1, wherein two sweep signals used for modulation of the binary signal and two FIR filter coefficients used for demodulation are defined as

y₁[n]=sin(αn²+βn+r) (0 n<N)

y₂[n]=y₁[N−1−n] (0 n<N)

where N is length of sweep signal y₁[n], y₂[n], α, β and γ are arbitrary constants.

The invention of claim 6 is the digital modem of claim1, wherein two sweep signals used for modulation of said binary signal are defined as equation(01)

y₁[n]=sin(αn²+βn+r) (0 n<N)

y₂[n]=y₁[N−1−n] (0 n<N),

two FIR filter coefficients used for demodulation thereof are defined as equation(02)

$$\begin{matrix}{h}_{1} [ n ] = \{ \begin{matrix}1 & ( if 0 ≦ {y}_{1} [ n ] \\ - 1 & ( if {y}_{1} [ n ] < 0 )\end{matrix} & \\ {h}_{2} [ n ] = {h}_{1} [ N - 1 - n ] & ( 0 ≦ n < 0 ) ,\end{matrix}$$

h₂[n]=h₁[N−1−n] (0±n<N),

where N is length of sweep signal y₁[n], y₂[n] and FIR filter coefficient h₁[n], h₂[n], α, β, γ are arbitrary constants.

### DETAILED DESCRIPTION OF PREFERRED EMBODIMENTS

Now, embodiments of the present invention will be described referring to drawings.

FIG. 1 shows the signal flow of a digital modem to which the present invention is applied.

The digital modem comprises a modulation circuit 1 and a demodulation circuit 2, for modulation/demodulation of 1/−1 binary signal.

When a binary signal of value 1 or 0 is treated, it may be simply considered by substituting the signal of value −1 with the value 0.

In the drawing, 11 of the modulation circuit 1 is a generator of sequence h[k] of finite length, and 12 is a generator of sequence h[−k] of finite length, which is h[k] whose time axis is inverted.

When these circuits are realized by hardware, ROM (Read Only Memory) circuit may be used.

A switch 13 is a selector for changing over h[k] and h[−k] according to 1 or −1 input signal, and selects the output of the generator 11 generating h[k] when the input signal is 1, and selects the output of the generator 12 generating h[−k] when the input signal is −1.

At this point, by reversing the symbol, it goes without saying that h[−k] is generated if an input signal is 1 and h[k] is generated if an input signal is −1.

Here, the generators 11,12 are based on digital processing and also may be analogue processing.

In this case, for an analogue processing device, VCO and SAW oscillator or the like are preferably capable of generating a wide band sweep signal.

In the first embodiment, the sequence h[k] of finite length is generated as follows.

$$\begin{matrix}H [ n ] = \begin{matrix}exp [ J \frac{2 π}{L} \frac{1}{α} {n}^{2} ] = cos [ \frac{2 π}{L} \frac{1}{α} {n}^{2} ] + {jsin [ \frac{2 π}{L} \frac{1}{α} {n}^{2} ]}_{( 0 ≦ n ≦ L / 2 )} \\ H * [ L - n ] = cos [ \frac{2 π}{L} \frac{1}{α} {( L - n )}^{2} ] - jsin [ \frac{2 π}{L} \frac{1}{α} L - n {{)}_{( L / 2 < n < L )}}^{2} ]\end{matrix} & ( 1 ) \\ H [ n ] = \{ \begin{matrix}cos β {n}^{2} + j sin β {n}^{2} & & ( 0 ≦ n ≦ L / 2 ) \\ cos {β ( L - n )}^{2} - j sin {β ( L - n )}^{2} & ( L / 2 < n < L ) & \end{matrix} & {( 1 )}^{′} \\ 1 ≦ α & ( 2 ) \\ g [ k ] = real ( IDFT ( H [ n ] ) ) = real [ \frac{1}{L} {\sum }_{n = 0}^{L - 1} H [ n ] exp [ j \frac{2 n}{L} kn ] ] ( 0 ≦ k < L ) & ( 3 ) \\ h [ k ] = \{ \begin{matrix}g [ k + \frac{L}{2} [ 1 - \frac{1}{α} ] ] [ 0 ≦ k < \frac{L}{2} [ 1 - \frac{1}{α} ] ] \\ g [ k - \frac{L}{2} [ 1 + \frac{1}{α} ] ] [ \frac{L}{2} [ 1 - \frac{1}{α} ] ≦ k < L ]\end{matrix} & ( 4 )\end{matrix}$$

IDFT: inverse discrete Fourier transform

L: penod *: complex conjugate j²=−1

A complex sequence H[n] of length L shown in the equation (1) is inverse Fourier transformed as shown by the equation (3) before taking the real part to generate a sequence g[k], and further, g[k] is shifted circularly to the left as shown in the equation (4) to obtain h[k].

The parameter α in the equation (1), (3), (4) is a parameter to define the nature of h[k].

The value of the parameter α is enough larger than 1, and in general, it may be 2.

Examples of h[k], h[−k] generated with the length L=512, parameter α=2 by the equations (1), (3), (4) are shown respectively in FIG. 2 and FIG. 3.

Here, the sequence h[k] generated by the equations (1), (3), (4) is known as TSP (Time Stretched Pulse) and the generation method thereof is publicly known.

Besides, 21 of the demodulation circuit 2 is FIR filter having as filter coefficient the sequence h[−k] which is h[k] whose time axis is inverted, and 22 is FIR filter having as filter coefficient the sequence h[k].

23 and 24 are square multipliers.

Input modulations signals are filtered and output respectively by the FIR filters 21, 22, squared by the square multipliers 23, 24, and the difference of results is determined to obtain the demodulation output.

Here, in case where the input signal is the sequence h[k], the output from the FIR 21, in short, linear convolution of h[k] and h[−k] becomes an impulse as shown in FIG. 4. The linear convolution of two signals is defined by the equation

$$\begin{matrix}y [ n ] = h [ n ] * x [ n ] \\ = {\sum }_{k = 0}^{L - 1} h [ k ] x [ n - k ]\end{matrix} \qquad ( 7 )$$

On the other hand, the output from the FIR 22, in short, linear convolution of h[k] and h[k] becomes a signal of narrow amplitude as shown in FIG. 5.

In case where the input signal is the sequence h[−k], the output from the FIR 21 becomes the signal shown in FIG. 5, and the output from the FIR 22 becomes the signal shown in FIG. 4.

Consequently, a pulse train having a polarity corresponding to the value of binary signal input of the modulation circuit 1 to output from the demodulation circuit 2 is obtained.

Here, FIR filters 21, 22 are based on digital processing and also may be analogue processing.

In this case, an analogue processing device has a characteristic that the higher the frequency is, the larger the delay time is.

For example, CCD and SAW variance type delay lime or the like are preferably used.

In case of the first embodiment, the linear convolution of h[k] and h[−k] becomes an impulse, allowing to obtain the impulse response itself of the transfer system as demodulated output.

Therefore, the transfer system characteristics can be compensated using the demodulated output during signal reception.

In the second embodiment, a sequence h[k] generated by the expression [5] is used. The sequence h[k] generated here corresponds to the h[k] generated by the equations (1), (2), (4) , clipped and two-valued, and has the nature of cross-correlation and linear convolution similar to the h[k] generated by the equations (1), (2), (4) .

$$h [ k ] = 1 - 2 {mod}_{2} [ \frac{{k}^{2}}{2 L} ] \\ \begin{matrix}{mod}_{2} ( x ) : & x modulo 2 \\ : & floor\end{matrix} \qquad ( 5 )$$

$$\frac{x - {mod}_{2} ( x )}{\begin{matrix}2 \\ n : integer\end{matrix}} = n \qquad ( 6 )$$

in the equation (5), mod₂ represents the remainder operation taking 2 as divisor.

x is an integer not exceeding x, namely operator for rounding the real x to an integer.

The length of the sequence to be generated is specified by L.

The generated signal becomes a binary value having the value 1 or −1.

Examples of h[k] generated by the equation (5), taking 40 as the value of L and h[−k] which is h[k] whose time axis is inverted are shown respectively in FIG. 6 and FIG. 7.

Here, in case where the input signal of the demodulation circuit 2 is the sequence h[k], the output from the FIR 21, in short, linear convolution of h[k] and h[−k] becomes a signal in impulse form as shown in FIG. 8.

On the other hand, the output from the FIR 22, in short, linear convolution of h[k] and h[k] becomes a signal of small amplitude as shown in FIG. 9.

In case where the input signal is the sequence h[−k], the output from the FIR 21 becomes the signal shown in FIG. 9, and the output from the FIR 22 becomes the signal shown in FIG. 8.

In case of the second embodiment, h[k] and h[−k] being binary signal, it can be realized by an extremely simple circuit, in case of hardware embodiment.

To be more specific, examples of modulation signal and demodulated output signal will be shown below.

In case where the input signal of the modulation signal 1 is a 8 bit {1, −1, 1, 1, −1, 1, −1, −1} shown in FIG. 10, the output from the modulation circuit 1 will be as shown in FIG. 11.

When the modulation signal shown in FIG. 11 is input to the demodulation circuit 2, the demodulated output becomes a signal in pulse form shown in FIG. 12.

The pulse polarity of demodulation output corresponds to the value of the input signal of FIG. 10.

A bit train of value 1 or −1 can be restored easily from the signal of FIG. 12, by employing a demodulation circuit 2 using DLL (Delay Locked Loop).

In the third embodiment, two sweep signals used for modulation are generated on a basis of the definition of equation(01).

y₁[n]=sin(αn²+βn+r) (0±n<N)

y₂[n=y₁[N−1−n] (0±n<N)

Examples of the two sweep signals y₁[n], y₂[n] generated by designating values of α, β, γ as 0.001, 0, 0 in equation(01) are respectively shown in FIG. 28, 29.

Further, the result of linear convolution processing of y₁[n], y₂[n] are shown in FIG. 30. The result of linear convolution processing of y₁[n], y₁[n] are shown in FIG. 31.

From the result of linear convolution of FIG. 30 and FIG. 31, if y₁[n] and, y₂[n] are used for modulation and demodulation, the circuit using FIR filter taken y₁[n], y₂[n] as coefficients is capable of demodulating a signal.

The results of modulation/demodulation are shown in FIG. 36 and FIG. 37.

FIG. 36 is a modulation waveform using y₁[n], y₂[n] and FIG. 37 is a demodulation waveform thereof.

In the fourth embodiment, two sweep signals y₁[n], y₂[n] used for modulation are generated on a basis of the definition of equation(01).

y₁[n]=sin(αn²+βn+r) (0±n<N)

y₂[n]=y₁[N−1−n] (0±n<N)

Two FIR filter coefficients h₁[n], h₂[n] used for demodulation are defined as equation(02).

$$\begin{matrix}{h}_{1} [ n ] = {\{}^{1} & ( if 0 ≦ {y}_{1} [ n ] & \\ - 1 & ( if {y}_{1} [ n ] < 0 ) & \\ {h}_{2} [ n ] = {h}_{1} [ N - 1 - n ] & & ( 0 ≦ n < N ) ,\end{matrix}$$

h₂[n]=h₁[N−1−n] (0±n<N),

Examples of two sweep signals y₁[n], y₂[n] generated by designated values of α, β, γ as 0.001,0,0 in equation(01) are shown in FIG. 28, FIG. 29.

Further, FIR filter coefficients h₁[n], h₂[n] generated on a basis of the definition of equation(02) are shown in FIG. 32, FIG. 33.

Furthermore, the results of linear convolution processing of y₁[n] and h₂[n] are shown in FIG. 34. The results of linear convolution processing of y₁[n] and h₁[n] are shown in FIG. 35.

From the results of linear convolution processing of FIG. 34 and FIG. 35, if y₁[n] and y₂[n] are used for modulation, the circuit using FIR filter taken y₁[n] and y₂[n] as coefficients is capable of demodulating a signal. The results of modulation/demodulation are shown in FIG. 36 and FIG. 38. FIG. 36 shows a modulation waveform using y₁[n] and y₂[n]. FIG. 38 shows waveform of a signal demodulated using FIR filter taken h₁[n] and h₂[n] as coefficients.

As mentioned above, the digital modem of the present invention comprises a modulation circuit for outputting as modulation signal either the signal h[k] whose amplitude frequency characteristics are constant, and the phase thereof varies in proportion to the square of the frequency (namely, group delay proportional to the frequency) or the signal h[−k] which is the signal h[k] right and left inversed on the time axis according to a binary signal of 1/−1 and a demodulation circuit for determining the difference between the square after linear convolution of this modulation signal and the signal h[−k] which is the sequence h[k] right and left inversed on the time axis, and the square after linear convolution of the modulation signal and the sequence h[k], outputting as a demodulation signal an impulse signal train having the pulse polarity corresponding to the binary signal of the transmission signal.

Consequently, the present invention allows to realize a digital processing using the sequence h[k] whose characteristics are strictly defined and, at the same time, to simplify the apparatus and thereby improve the reliability and economy, because complicated generation circuits of diffusion symbol required conventionally for the transmitter and the receiver become both unnecessary.

In addition, the demodulation circuit 2 can be simply composed only of digital filters such as DSP having the sequence h[k] as filter coefficient, complicated synchronous control for receiving a signal being unnecessary.

Further, it is resistant to intermittent pulse noise, as the modulation/demodulation is performed by a kind of pulse signal expansion/compression on the time axis.

Such resistance to the noise is described below.

As shown in FIG. 27, suppose that input signal of the demodulation circuit y[i], outputs from two FIR digital filters respectively are p1[i], p2[i], outputs from two square circuits respectively p₁²[i], p₂²[i], and output from the demodulation circuits w[i].

Here, as shown by the following equation, the input y[i] is supposed to be the sum of the modulation signal h[i ] and additional random noise n[i].

y[i]=h[i]+n[i]

p1[i], p₁²[i] are determined as follows. Here, * is an operator representing the linear convolution, h′[i] is sequence h[i] whose time axis is inverted, and δ [i] a digital function.

As described already, the linear convolution of h[i] and h′[i] becomes substantially a delta function.

$$\begin{matrix}{p}_{1} [ i ] = y [ i ] * {h}^{′} [ i ] = ( h [ i ] + n [ i ] ) * {h}^{′} [ i ] \\ = h [ i ] * {h}^{′} [ i ] + n [ i ] * {h}^{′} [ i ] \\ = δ [ i ] + n [ i ] * {h}^{′} [ i ]\end{matrix}$$

$$\begin{matrix}{p}_{1}^{2} [ i ] = {( δ [ i ] + n [ i ] * {h}^{′} [ i ] )}^{2} \\ = {δ}^{2} [ i ] + 2 δ [ i ] \cdot n [ i ] * {h}^{′} [ i ] + {( n [ i ] * {h}^{′} [ i ] )}^{2}\end{matrix}$$

Next, p2[i], p22[i] are determined as follows. Here, m[i] is the linear convolution of h[i] and h[i] and, as described already, is a low power signal whose amplitude is near 0.

$$\begin{matrix}{p}_{2} [ i ] = y [ i ] * h [ i ] = ( h [ i ] + n [ i ] ) * h [ i ] \\ = h [ i ] * h [ i ] + n [ i ] * h [ i ] \\ = m [ i ] + n [ i ] * h [ i ]\end{matrix}$$

$$\begin{matrix}{p}_{2}^{2} [ i ] = {( m [ i ] + n [ i ] * h [ i ] )}^{2} \\ = {m}^{2} [ i ] + 2 m [ i ] \cdot n [ i ] * h [ i ] + {( n [ i ] * h [ i ] )}^{2}\end{matrix}$$

Next, the output w[i] of the demodulation circuit is determined as follows.

$$\begin{matrix}w [ i ] = {p}_{1}^{2} [ i ] - {p}_{2}^{2} [ i ] \\ = {δ}^{2} [ i ] + 2 δ [ i ] \cdot n [ i ] * {h}^{′} [ i ] + {( n [ i ] * {h}^{′} [ i ] )}^{2} - {m}^{2} [ i ] - \\ 2 m [ i ] \cdot n [ i ] * h [ i ] - {( n [ i ] * h [ i ] )}^{2} \\ = δ [ i ] + 2 δ [ i ] \cdot n [ i ] * {h}^{′} [ i ] - {m}^{2} [ i ] - 2 m [ i ] \cdot n [ i ] * h [ i ] + \\ {( n [ i ] * {h}^{′} [ i ] )}^{2} - {( n [ i ] * h [ i ] )}^{2} \\ = δ [ i ] ( 1 + 2 \cdot n [ i ] * {h}^{′} [ i ] ) - {m}^{2} [ i ] - 2 m [ i ] \cdot n [ i ] * h [ i ] + \\ {( n [ i ] * {h}^{′} [ i ] )}^{2} - {( n [ i ] * h [ i ] )}^{2}\end{matrix}$$

If the random noise n[i] is stationary in an interval shorter than the length of h[i] and h′[i], the squares of the linear convolution of h[i] and h′[i] become equal each other.

(n[i]*h[i])²−(n[i]*h′[i])²

Consequently, w[i] becomes as follows.

w[i]*δ[i](1+2·n[i]*h′[i])−m²[i]−2m[i]·n[i]* h[i]

The value of the second term and the third term of the light side of the foregoing expression, being the product of narrow amplitude signals each other, can be taken as substantially 0.

|m[i]|<1

|n[i]*h′[i]|<1

|n[i]*h[i]|<1

Consequently, w[i] becomes further as follows.

$$\begin{matrix}w [ i ] & * δ [ i ] ( 1 + 2 \cdot n [ i ] * {h}^{′} [ i ] ) \\ & = δ [ i ] ( 1 + {k}_{1} )\end{matrix}$$

Here, k₁ is a small constant whose absolute value is equal or inferior to 1.

|k₁|<1

Therefore, it is understood that the modulation/demodulation method of this method can perform the demodulation processing without being substantially influenced by noise when random noise is applied to the transfer path, and only the pulse amplitude of the demodulation output varies.

Besides, in case where the input of the demodulation circuit is the sum of the modulation signal h′[i], namely h[i] whose time axis is inverted and the random noise n[i], w[i] becomes as follows.

In this case also, it is understood that only the negative pulse amplitude varies.

$$\begin{matrix}w [ i ] - δ [ i ] ( 1 - 2 \cdot n [ i ] * h [ i ] ) = \\ - δ [ i ] ( 1 + {k}_{2} ) \\ \vert {k}_{2} \vert < 1\end{matrix}$$

Further, FIG. 13 to FIG. 20 shows examples of demodulation output waveform, in case where random noise is actually applied to the modulation wave in the transfer path.

### BRIEF DESCRIPTION OF THE SEVERAL VIEWS OF THE DRAWING

FIG. 1 shows the signal flow of a digital modem to which the present invention is applied;

FIG. 2 shows h[k] generated by equations (1), (3), (4) supposing L=512 and α=2;

FIG. 3 shows a sequence h[−k] which is h[k] shown in FIG. 2 whose time axis is inverted;

FIG. 4 are linear convolution of h[k] shown in FIG. 2 and h[−k] shown in FIG. 3;

FIG. 5 are linear convolution of h[k] and n[k] itself shown in FIG. 2, or linear convolution of h[−k] and h[−k] itself shown in FIG. 3;

FIG. 6 is h[k] generated by the equation (5) supposing L=40;

FIG. 7 shows a sequence h[−k] which is h[k] shown in FIG. 6 whose time axis is inverted;

FIG. 8 are h[k] shown in FIG. 6 and linear convolution of h[−k] shown in FIG. 7;

FIG. 9 are h[k] and linear convolution of n[k] itself shown in FIG. 6, or h[−k] and linear convolution of h[−k] itself shown in FIG. 7;

FIG. 10 is an example of input signal to the modulation circuit, 8bit serial signal of {1, −1, 1, 1, −1, 1, −1, −1};

FIG. 11 shows a modulation output signal when the signal of FIG. 10 is applied as input to the modulation circuit of FIG. 1; however, here, the generators 11, 12 are supposed to output the binary signals shown respectively in FIG. 6, FIG. 7;

FIG. 12 shows the demodulation output signal when the modulation signal of FIG. 11 is applied as input to the demodulation circuit of FIG. 1; however, here, the coefficients of FIR filters 21, 22 are supposed to be binary values h[−k], h[k] shown respectively in FIG. 7, FIG. 6;

FIG. 13 is an example of modulation waveform of the first embodiment, wherein the modulation is performed by the circuit of FIG. 1, by taking as input a 9bit serial signal of {−1, 1, −1, −1, 1, 1, 1, −1, 1}.

The sequence h in FIG. 1 uses the one generated by expressions (1), (3), (4).

Here, parameters in the expressions are set to L=64 and α=1;

FIG. 14 shows a demodulation output when the signal of FIG. 13 is input to the demodulation circuit; it is understood that a pulse train corresponding to the bit train {−1, 1, −1, −1, 1, 1, 1, −1, 1} input to the modulation circuit of FIG. 1 is output;

FIG. 15 shows a waveform on evenly distributed noise;

FIG. 16 shows a signal waveform wherein noise of FIG. 15 is added to the modulation waveform of FIG. 13;

FIG. 17 shows the demodulation output of the signal of FIG. 16 by the circuit of FIG. 1, demonstrating that the modulation/demodulation method of the present invention is resistant to the noise, because the demodulation processing is performed normally even when random noise is added to the signal;

FIG. 18 shows a signal wherein sinusoidal waves of cycle 5.9 sample and cycle 13.2 sample are added;

FIG. 19 shows a signal waveform wherein the signal of FIG. 18 is added to the modulation waveform of FIG. 13;

FIG. 20 shows the demodulation output of the signal of FIG. 19 by the circuit of FIG. 1, demonstrating that the modulation/demodulation method of the present invention is resistant to the parasite, because the demodulation processing is performed normally even when cyclic parasite signal is applied;

FIG. 21 shows a signal waveform of the sweep signal h[i];

FIG. 22 shows a signal waveform of the sweep signal h′[i];

FIG. 23 shows a signal waveform approximating the sweep signal h[i] by a cos signal whose frequency varies gradually;

FIG. 24 shows a signal waveform approximating the sweep signal h′[i] by a cosine signal whose frequency varies gradually;

FIG. 25 is a graph showing that the nature of the cross-relation of \tilde{h}[i] and \tilde{h}[i] and \tilde{h}′[i] and \tilde{h}′[i] takes an impulse form;

FIG. 26 is a graph showing that the nature of the cross-relation of \tilde{h}[i] and \tilde{h}′[i] becomes substantially 0; and

FIG. 27 is signal processing diagram illustrating that the demodulation circuit of the present invention is resistant to noise.

FIG. 28 is an example of sweep signal y₁[n] generated by designating respectively values of α,β and γ as 0.001, 0 and 0 in equation(01).

FIG. 29 is an example of sweep signal y₂[n] generated by designating respectively values of α,β and γ as 0.001, 0 and 0 in equation(01).

FIG. 30 shows linear convolution of y₁[n] shown in FIG. 01 and y₂[n] shown in FIG. 02.

FIG. 31 shows linear convolution of y₁[n] shown in FIG. 01 and y₁[n] itself.

FIG. 32 shows FIR filter coefficient h₁[n] generated on a basis of the definition of equation(02).

FIG. 33 shows FIR filter coefficient h₂[n] generated on a basis of the definition of equation(02).

FIG. 34 shows linear convolution of y₁[n] shown in FIG. 01 and h₂[n] shown in FIG. 06.

FIG. 35 shows linear convolution of y₁[n] shown in FIG. 01 and h₁[n] shown in FIG. 05.

FIG. 36 shows modulation waveform using sweep signals y₁[n] and y₂[n] generated on a basis of the definition of equation(01).

FIG. 37 shows waveform of a signal demodulated using FIR filter waveform y₁[n] and y₂[n] generated on a basis of the definition of equation(01).

FIG. 38 shows waveform of a signal demodulated using FIR filter coefficients h₁[n] and h₂[n] generated on a basis of the definition of equation(02).

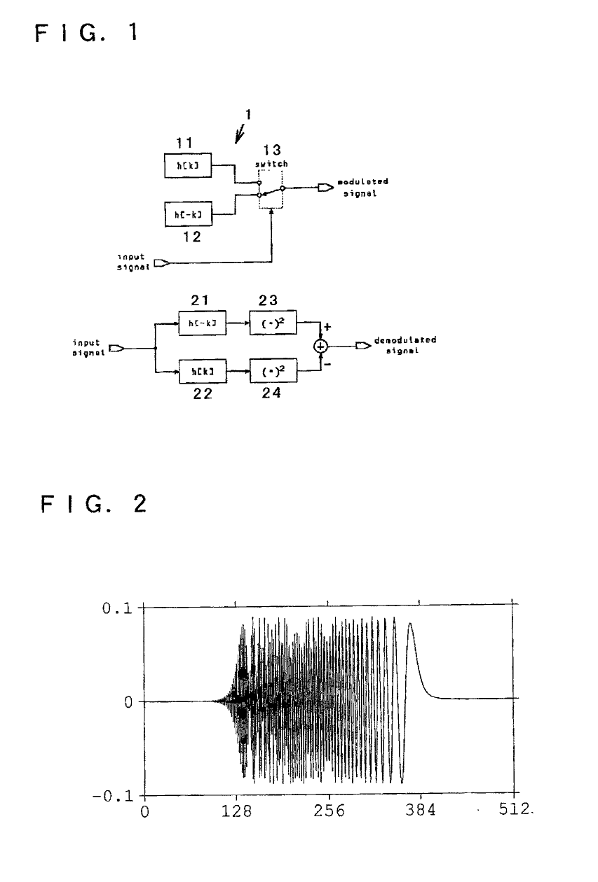

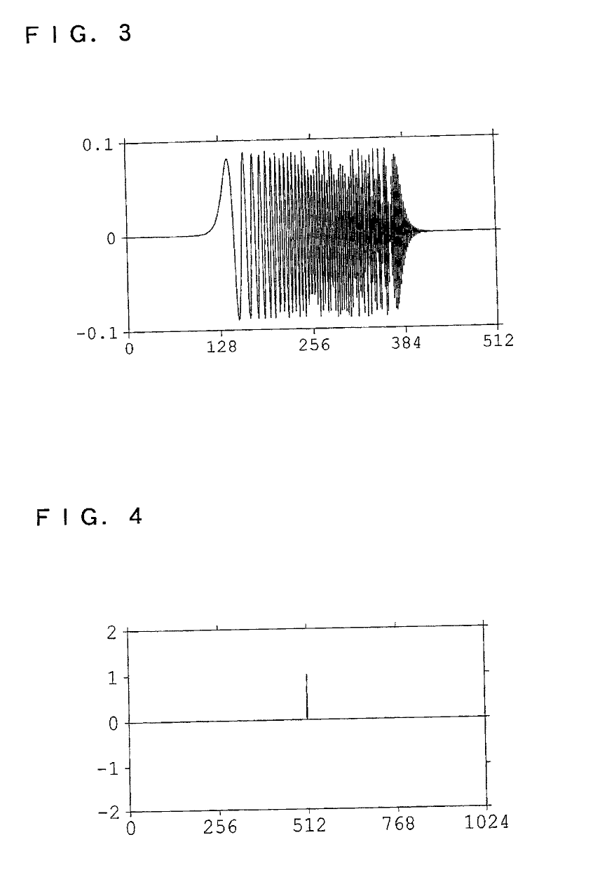

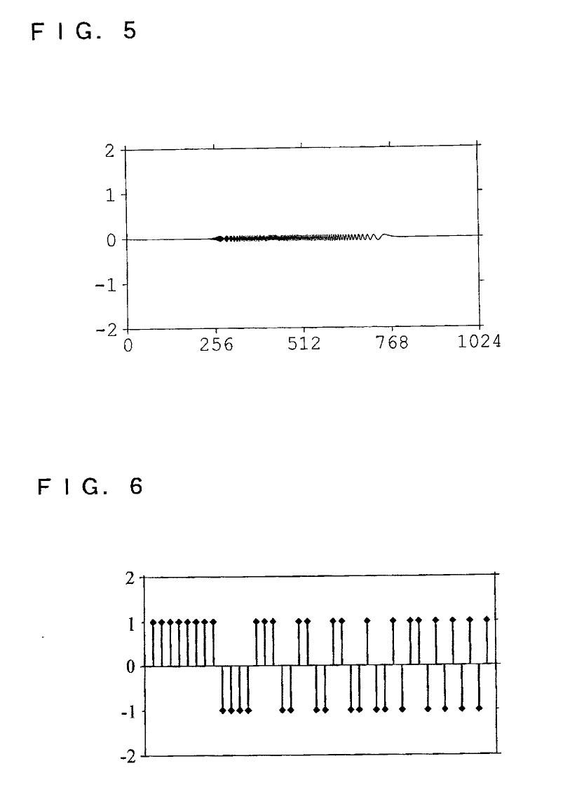

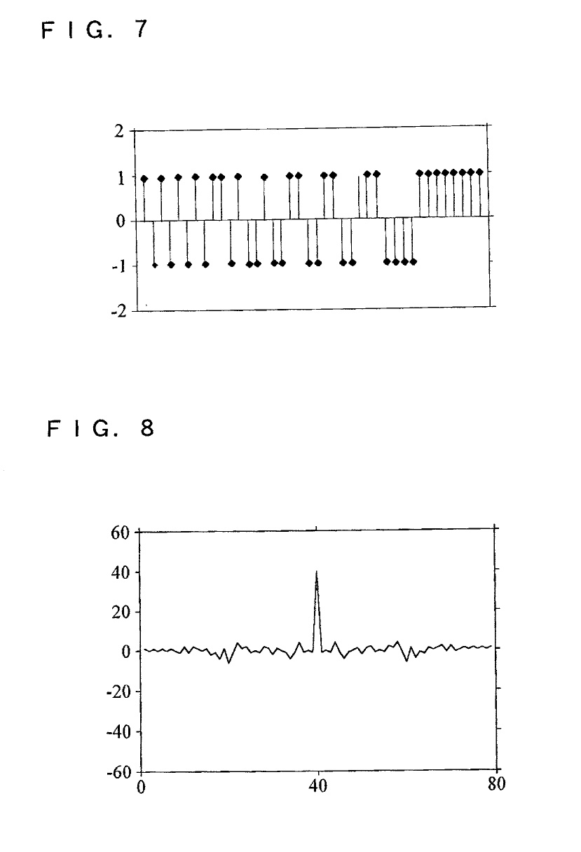

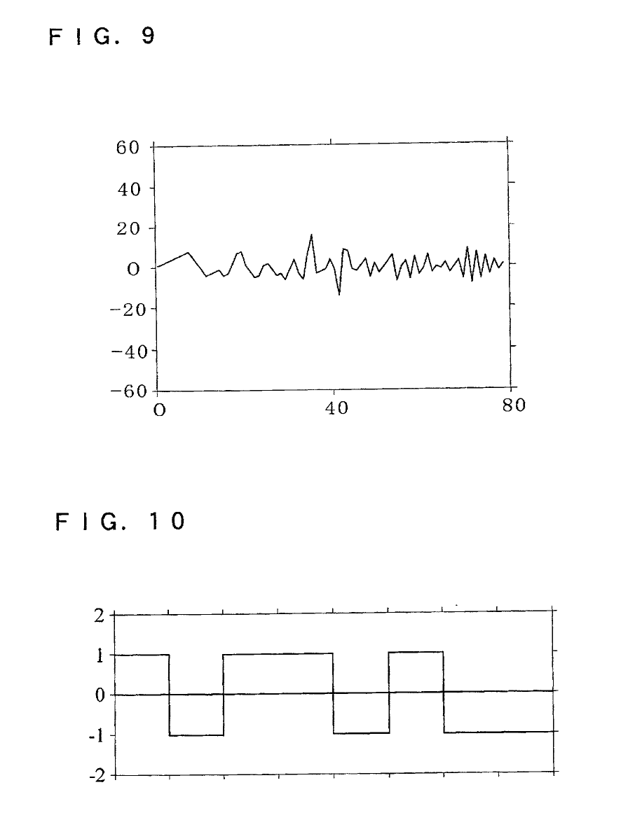

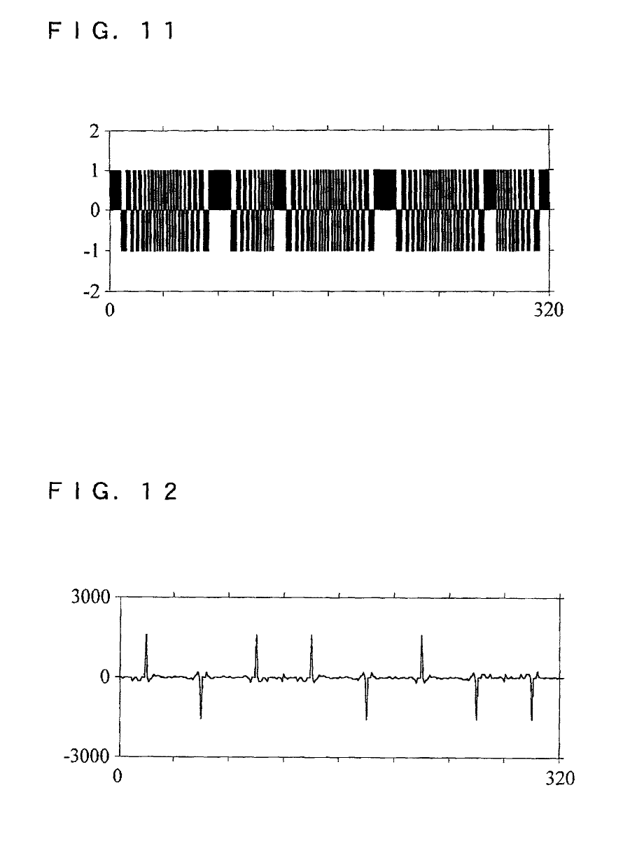

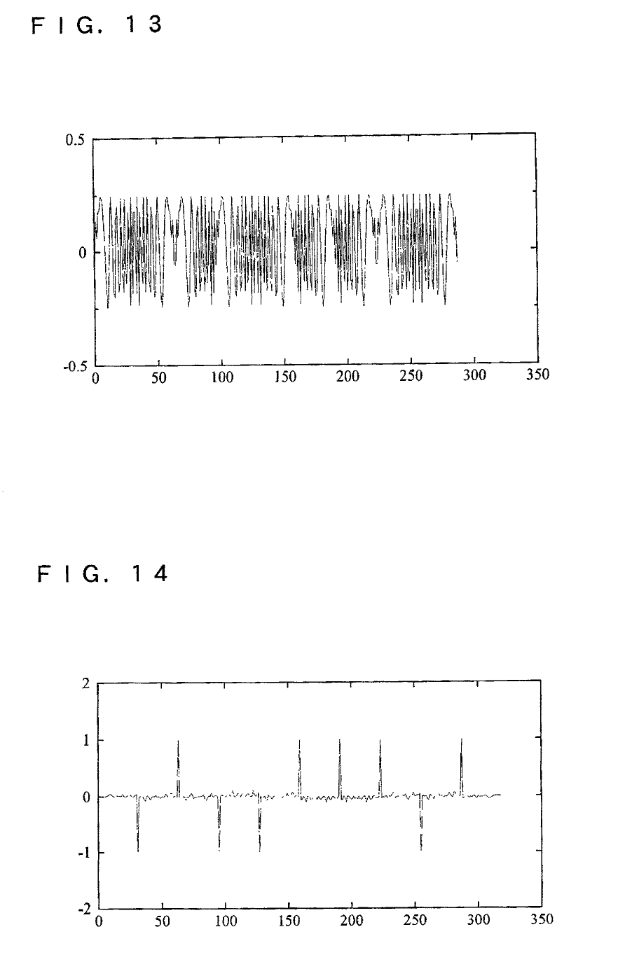

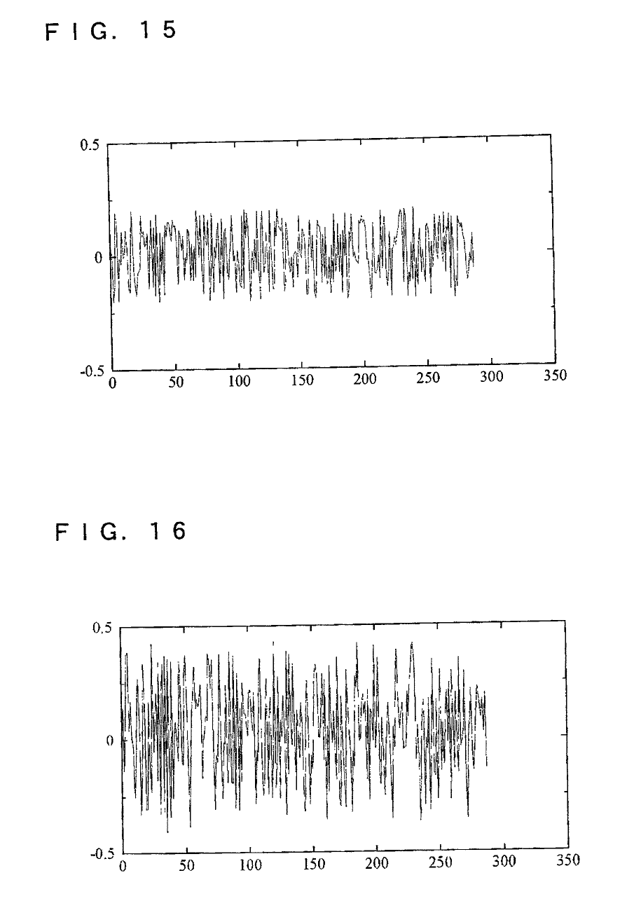

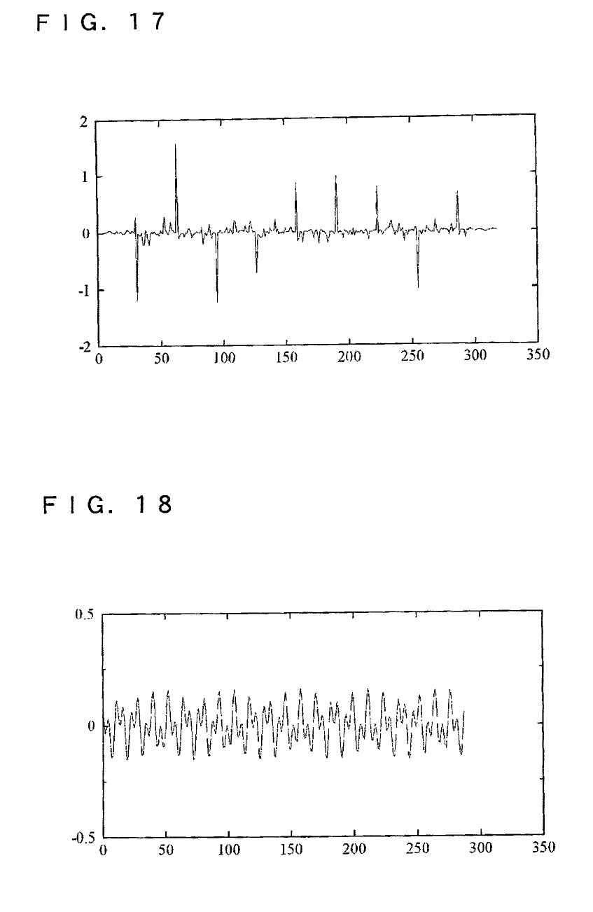

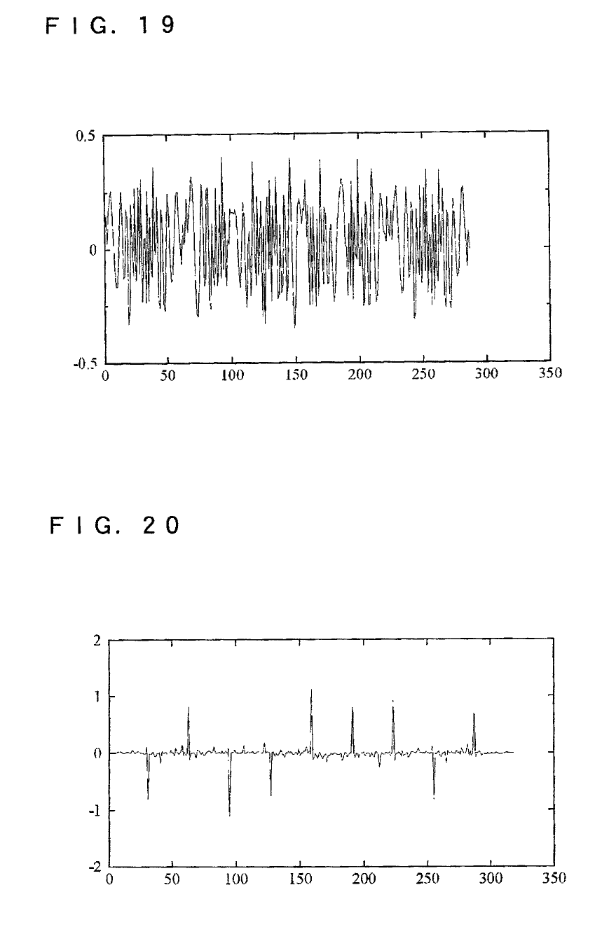

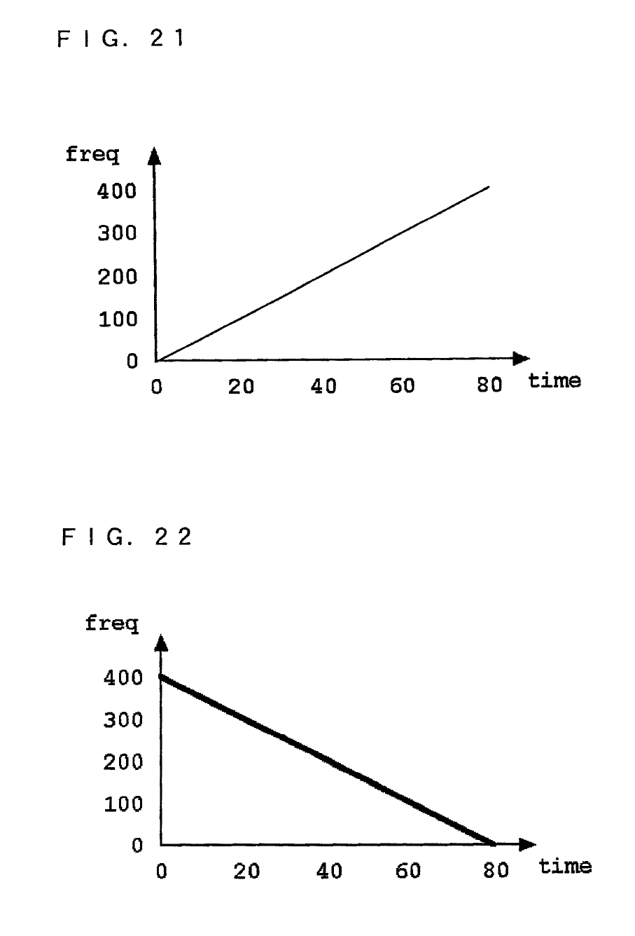

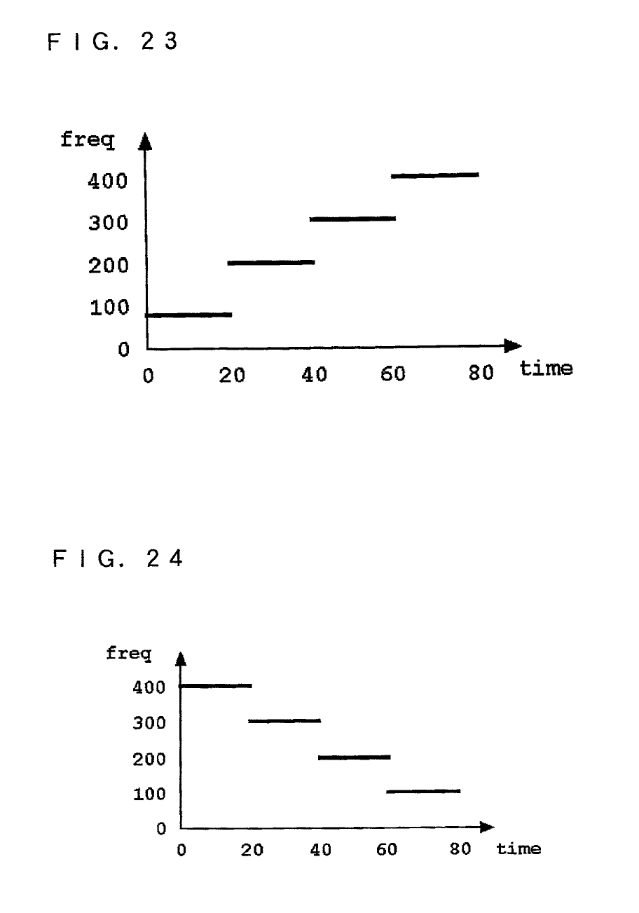

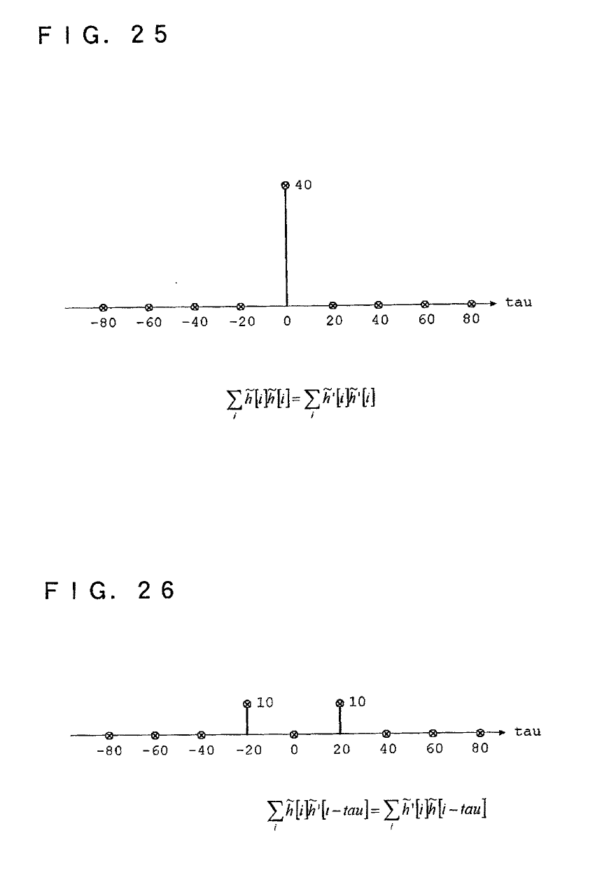

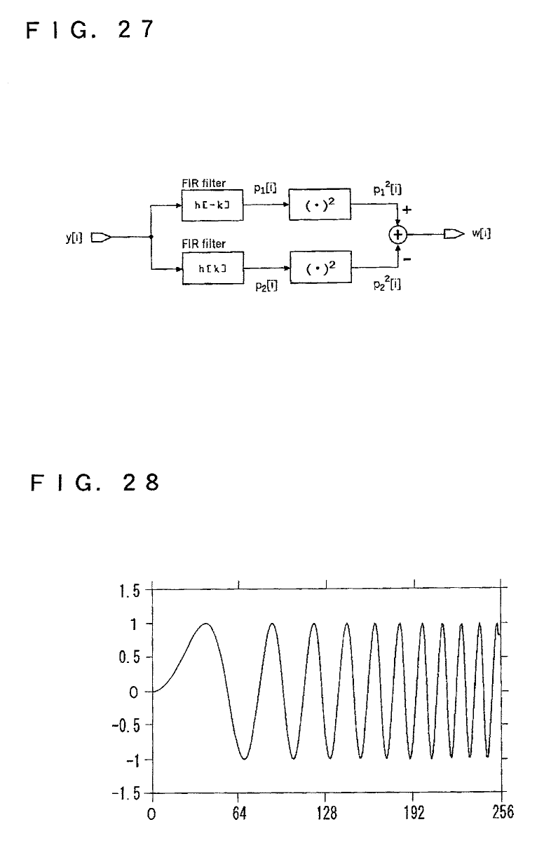

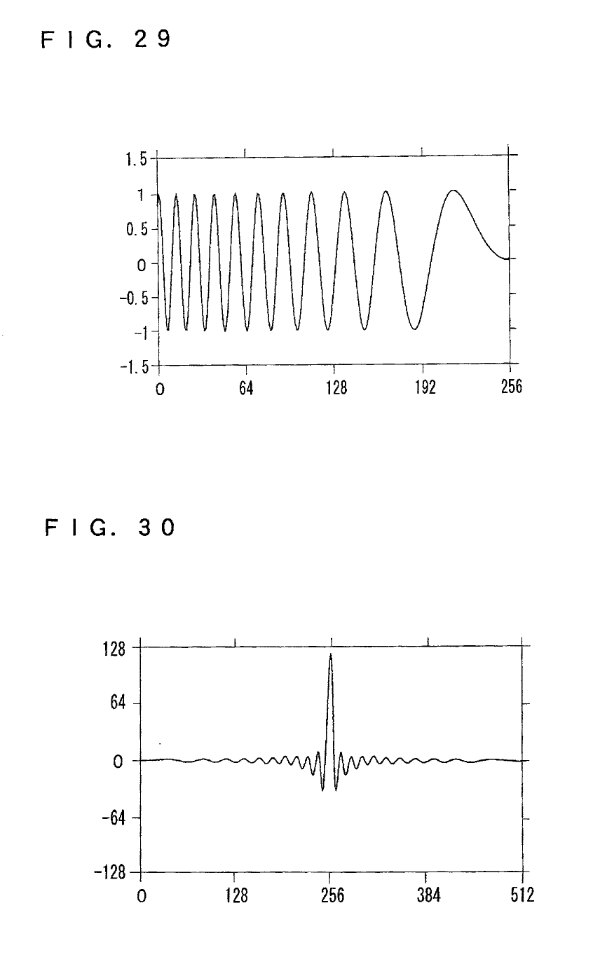

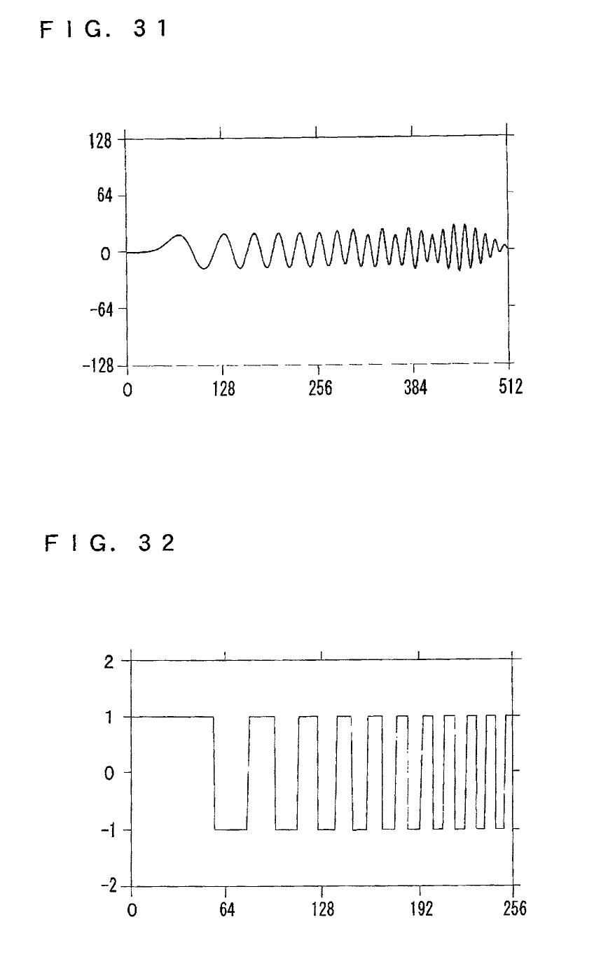

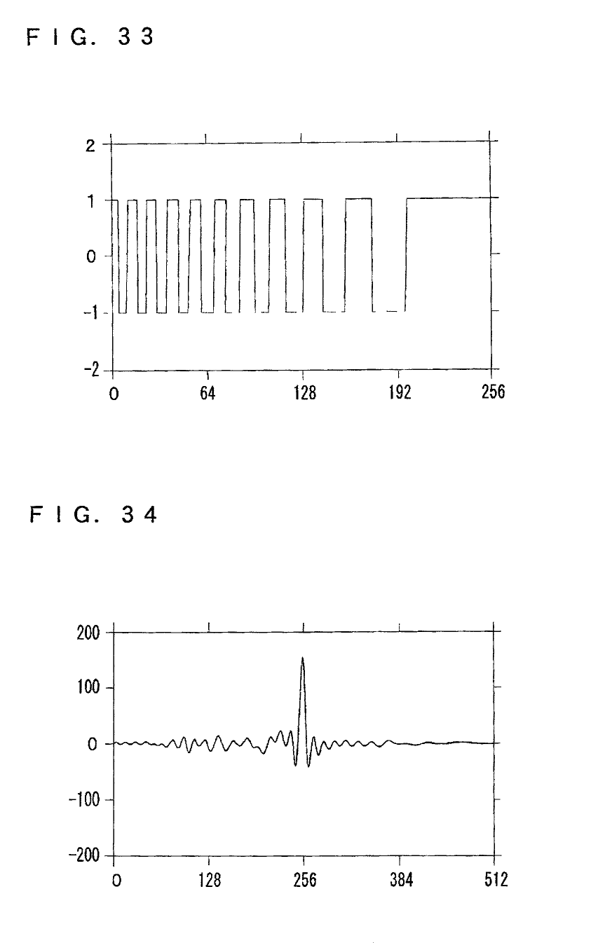

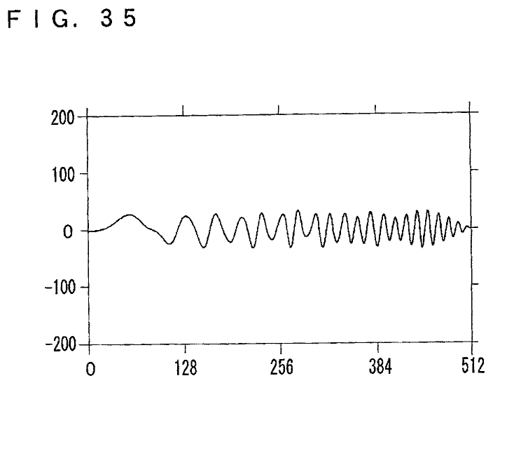

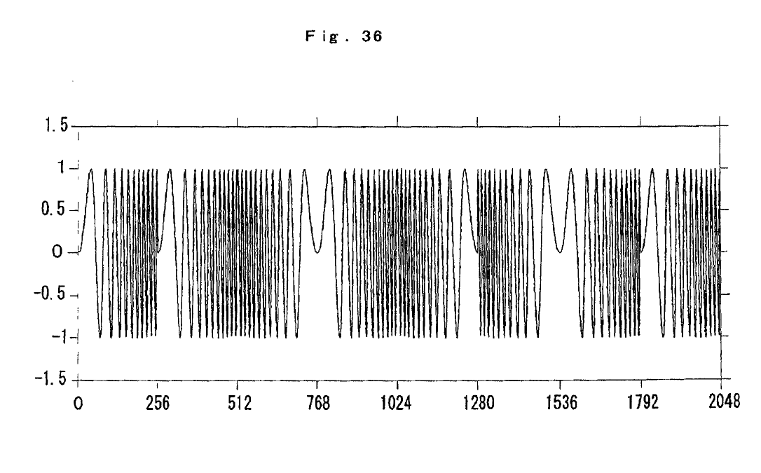

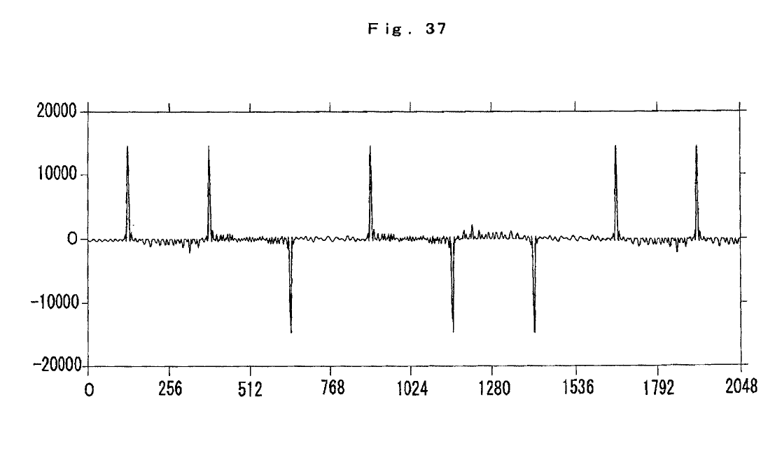

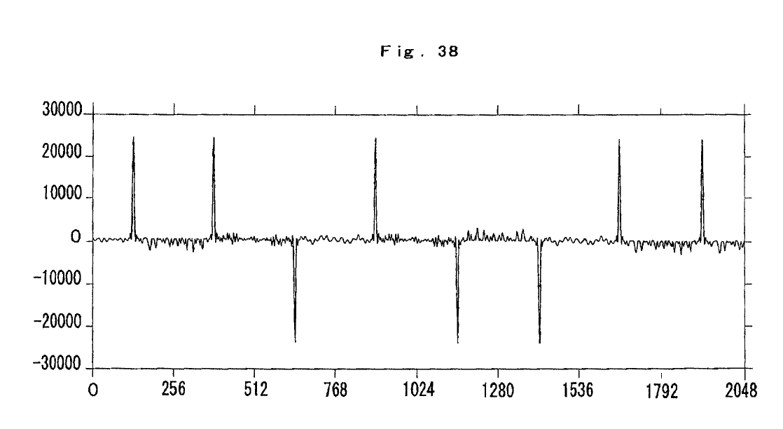

1. A digital modem, comprising:
a modulation circuit for outputting respectively as modulation signals,
a signal had whose amplitude frequency characteristic is constant, and the phase thereof varies in proportion to the square of the frequency (namely, group delay proportional to the frequency),
when a transmission symbol is 1, and
a signal h[−k] which is the signal h[k] right and left inversed on the time axis, when a transmission symbol is −1; and
a demodulation circuit for determining the difference between,
the square thereof after linear convolution of said modulation signal and the signal h[−k] which is the sequence h[k] right and left inversed on the time axis, and
the square thereof after linear convolution of the modulation signal and the sequence h[k],
for modulation/demodulation of 1/−1 binary signal.

2. The digital modern of claim 1, wherein an analogue circuit is adopted for output processing of a modulation signal in said modulation circuit and/or convolution processing of a modulation signal in said demodulation circuit.

3. The digital modem of claim 1, wherein:
said signal h[k] is a series h whose discrete Fourier transform is
$$DFT ( h [ k ] ) = \{ \begin{matrix}cos β {n}^{2} + j sin β {n}^{2} & ( 0 \leq n \leq L / 2 ) \\ cos β {( L - n )}^{2} - j sin β {( L - n )}^{2} & ( L / 2 < n < L )\end{matrix}$$
where, L is the length of the series h, the range of k is 0±k<L, and β is a constant taking a value other than 0.

4. The digital modem of claim 1, wherein:
said signal h[k] is a sequence h making:
$$h [ k ] = 1 - 2 {mod}_{2} [ \frac{{k}^{2}}{2 L} ]$$
where, L is the length of the series h, the range of k is 0±k<L, mod₂(x) is the remainder of division of x by 2, and x is an integer not exceeding x.

5. The digital modem of claim1, wherein two sweep signals used for modulation of said binary signal and two FIR filter coefficients used for demodulation are defined as
y₁[n]=sin(αn²+n−r) (0±n<N)
y₂[n]=y₁[N−1−n] (0±n<N)
where N is length of sweep signal y₁[n], y₂[n], and α, β, γ are arbitrary constants.

6. The digital modem of claim 1, wherein two sweep signals used for modulation of said binary signal are defined as equation(01)
y₁[n]=sin(αn²+βn−r) (0±n<N)
y₂[n]=y₁[N−1−n] (0±n<N), and,
two FIR filter coefficients used for demodulation thereof are defined as equation(02)
$${h}_{1} [ n ] = \{ \begin{matrix}1 & ( if 0 ≦ {y}_{1} [ n ] \\ - 1 & ( if {y}_{1} [ n ] < 0 )\end{matrix}$$
h₂[n]=h₁[N−1−n] (0±n<N),
where N is length of sweep signal y₁[n], y₂[n], and FIR filter coefficient h₁[n], h₂[n],and α, β, γ are arbitrary constants.
